(19) United States
(12) Patent Application Publication
(10) Pub. No.: US 2017/0068405 A1
(43) Pub. Date: Mar. 9, 2017

(54) HIDING AND DISPLAYING APPLICATIONS

(71) Applicant: APPLE INC., Cupertino, CA (US)

(72) Inventors: Ron D. LUE-SANG, Union City, CA (US); Mark S. KOLICH, Cupertino, CA (US); Zachary A. FRIEDMAN, Cupertino, CA (US); Betim DEVA, Cupertino, CA (US); Alexander T. REITTER, Sunnyvale, CA (US); Colin I. MELDRUM, Cupertino, CA (US); Alexandr IVANOV, Cupertino, CA (US); Vijay SUNDARAM, San Ramon, CA (US)

(21) Appl. No.: 15/256,297

(22) Filed: Sep. 2, 2016

Related U.S. Application Data
(60) Provisional application No. 62/214,860, filed on Sep. 4, 2015.

(51) Int. Cl. G06F 3/0482; H04L 29/06; H04L 29/08

(52) U.S. Cl. CPC G06F 3/0482; H04L 67/34; H04L 67/42

(57) ABSTRACT

In some implementations, a computing device can receive a display list that describes software applications to install and/or represent on a user interface of the computing device. The display list can specify software applications that the computing device should automatically download and install. The display list can specify an order for presenting or arranging representations of the software applications on the user interface of the computing device. The computing device can determine which system applications to hide based on the absence of a system application in the display list. In some implementations, a computing device can receive a hide list that describes software applications to hide from view on the user interface of the computing device. The hide list can specify software applications that are installed on the computing device but that should not be presented or represented on the user interface of the computing device.

### TECHNICAL FIELD

The disclosure generally relates to providing access to software applications on a graphical user interface.

### BACKGROUND

Many computing devices, such as set top boxes, streaming media players, smart phones, and tablet computers, are configured with software applications (e.g., web applications, native applications, etc.) that allow a user to consume media content. For example, a computing device can include a movie application that can stream movies from a media server to the user's television. The computing device can include a music application that can stream music from a user's personal music library stored on a laptop computer to the user's home music system. Some of the applications installed on the computing device can include proprietary applications built by the maker of the computing device. Some of the applications installed on the computing device can include third party applications built by other media services. For example, a third party that runs a video-sharing website can build an application that can be installed on the computing device and used to view the video content on the website. The software applications installed on the computing device can be represented by graphical objects on a graphical user interface of the computing device. The user can select a graphical object to invoke the corresponding software application.

### SUMMARY

In some implementations, a client device can receive a display list that describes software applications to install and/or represent on a user interface of the computing device. The display list can identify software applications that the computing device should automatically download and install. The display list can identify an order for presenting or arranging representations of the software applications on the user interface of the computing device. The computing device can determine which system applications to hide based on the absence of a system application in the display list. In some implementations, a computing device can receive a hide list that describes software applications to hide from view on the user interface of the computing device. The hide list can specify software applications that are installed on the computing device but that should not be presented or represented on the user interface of the computing device.

Particular implementations provide at least the following advantages. The maker of the computing device or a media content provider can use the display list to control which software applications are automatically installed on the computing device and represented on a user interface of the computing device. The maker of the computing device can use the display list to highlight certain software applications (e.g., such as proprietary applications, applications of business partners, etc.) over other software applications. The maker of the computing device can use the display list and/or the hide list to dynamically adjust which software applications are represented on the user interface of the computing device to accommodate different events and/or different locales.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is an example system for hiding and displaying software applications on client device.

FIG. 2 illustrates an example graphical user interface for presenting representations of applications installed on client device.

FIG. 3 illustrates an example graphical user interface for presenting representations of applications installed on client device.

FIG. 4 is flow diagram of an example process for automatically downloading applications from a server device.

FIG. 5 is a flow diagram an example process for displaying and hiding applications on a graphical user interface of client device.

FIG. 6 is a flow diagram of an example process for determining which applications to present on a graphical user interface of client device.

FIG. 7 is a block diagram of an example computing device that can implement the features and processes of FIGS. 1-6.

Like reference symbols in the various drawings indicate like elements.

### DETAILED DESCRIPTION

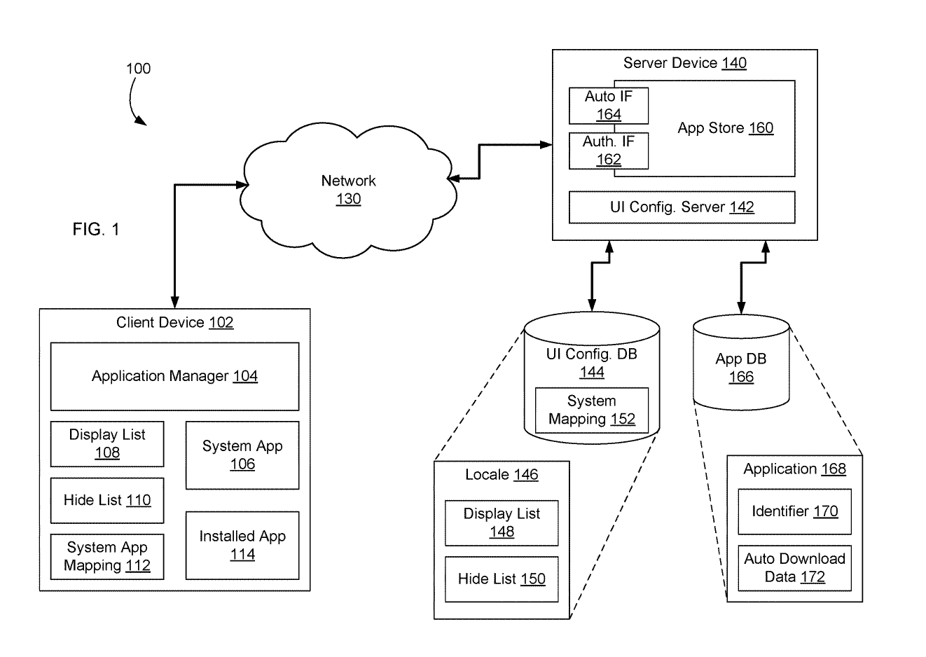

FIG. 1 is an example system 100 for hiding and displaying software applications on client device 102. For example, client device 102 can be a media streaming device, a set top box, a laptop computer, a smart phone, a tablet computer, or other computing device. In some implementations, client device 102 can include a display for presenting various graphical objects (e.g., icons, images, etc.) representing software applications (e.g., web applications, native applications, etc.) installed on client device 102. In some implementations, client device 102 can be connected to an external display device (not displayed) for presenting the various graphical objects representing software applications installed on client device 102. For example, client device 102 can generate a graphical user interface including graphical representations of the installed software applications and cause the graphical user interface to be presented on the external display device (e.g., television set, computer monitor, etc.), as described further below.

In some implementations, client device 102 can include application manager 104. For example, application manager 104 can be an operating system process. Application manager 104 can be preconfigured or preinstalled on client device 102, for example. In some implementations, application manager 104 can communicate with user interface configuration server 142 on server device 140 through network 130 to obtain user interface configuration data for client device 102. For example, network 130 can include a Wi-Fi network, a local area network, a wide area network, the Internet, or any other network that can connect client device 102 to server device 140.

In some implementations, interface manager 104 can request user interface configuration data for client device 102 upon startup of client device 102. For example, once a network connection is established between client device 102 and server device 140, application manager 104 can request user interface configuration data from user interface configuration server 142. In some implementations, application manager 104 can request user interface configuration data periodically (e.g., every 6 hours, every 24 hours, etc.). In some implementations, application manager 104 can send locale information (e.g., describing the current location, geographic region, country, etc.) to user interface configuration server 142 when requesting the user interface configuration data from user interface configuration server 142.

In some implementations, upon receipt of the user interface configuration data request from application manager 104, user interface configuration server 142 can obtain user interface configuration data from user interface configuration database 144. For example, upon receiving a user interface configuration data request from application manager 104 that specifies a locale for client device 102, user interface configuration server can send a query to user interface configuration database 144 for user interface configuration data for the specified locale.

In some implementations, user interface configuration database 144 can include user interface configuration data for different locales. For example, client device 102 can be sold to users in different locales (e.g., geographic areas, countries, etc.). The software applications available for installation or use on client device 102 can vary from locale to locale. For example, a movie application may be available for installation or use in a first locale (e.g., the United States) but may not be available for installation or use in a second locale (e.g., South Africa). Thus, user interface configuration database 144 can include different user interface configurations for different locales (e.g., locale configuration 146).

In some implementations, each locale configuration 146 can include display list 148 and/or hide list 150. In some implementations, display list 148 can specify software applications that should be automatically installed and accessible to a user on client device 102 in a corresponding locale 146. For example, display list 148 can include a listing of software application identifiers generated for software applications by application store 160. Hide list 150 can specify software applications that should be hidden on client device 102. For example, hide list 150 can include a listing of software application identifiers generated for software applications by application store 160. For example, application store 160 can be an online repository of applications that can be purchased by a user of client device 102 and/or downloaded to client device 102. Display list 148 and/or hide list 150 can be proprietary lists generated by the manufacturer of client device 102, for example. Display list 148 and/or hide list 150 can be proprietary lists generated by the proprietor of application store 160, for example. Display list 148 and/or hide list 150 can be modified or adjusted by the client device manufacturer or application store proprietor to adjust the look and feel of a graphical user interface (e.g., home screen, navigation window, etc.) of client device 102.

In some implementations, user interface configuration database 144 can include system mapping 152. For example, system mapping 152 can include a mapping of system application bundle identifiers (e.g., a string) to software application identifiers (e.g., an integer value) generated for system applications preconfigured on client device 102. For example, software application identifiers can be generated by application store 160 for software applications uploaded to and available for purchase from application store 160. Since system applications (e.g., applications that are built in to client device 102) are not available to purchase from application store 160, system applications typically do not have software application identifiers. System applications are typically identified on client device 102 using bundle identifiers that identify software packages by name (e.g., “com.example.movies.movieapp”). However, display list 148 and/or hide list 150 specify which software applications to display or hide based on software application identifier. Thus, in order to allow client device 102 to identify system applications to display or hide based on display list 148 and/or hide list 150, application store 160 can generate software application identifiers for the system applications on client device 102 and generate system mapping 152 that maps the bundle identifiers of the system applications to the software application identifiers generated for the system applications by application store 160. System mapping 152 can be stored in user interface configuration database 144 and delivered to client device 102 when client device 102 requests the user interface configuration data for a locale.

In some implementations, the user interface configurations (e.g., locale configuration 146, display list 148, hide list 150, system mapping 152) are not modifiable by users of client device 102. For example, users of client device 102 cannot change the software applications identified by display list 148, hide list 150, and/or system mapping 152 at server device 140 and/or at client device 102.

In some implementations, after user interface configuration server 142 obtains the user interface configuration data (e.g., display list 148, hide list 150, system mapping 152) for a locale, user interface configuration server 142 can send the local-specific user interface configuration data to application manager 104 on client device 102. For example, application manager 104 can store the received user interface configuration data locally on client device 102 as display list 108, hide list 110, and system application mapping 112.

In some implementations, client device 102 can be associated with multiple locales. For example, if client device 102 moves from one locale to another locale, client device 102 may receive user interface configuration data from server device 140 for one locale first and the other locale second. In some implementations, client device 102 can be configured to replace the user interface configuration data for the first locale with the user interface configuration data for the second locale upon receipt of the user interface configuration data for the second locale. In some implementations, client device 102 can aggregate the user interface configuration data for the first locale and the second locale. In some implementations, client device 102 can store the user interface configuration date for the first locale and the second locale separately and use which ever configuration data corresponds to the locale where client device 102 is currently located.

### Automatic Download of Applications

In some implementations, application manager 104 can automatically download applications from application store 160 to client device 102. For example, after application manager 104 receives display list 108, application manager 104 can determine which applications to automatically download from application store 160 based on the software applications identified in display list 108.

In some implementations, application manager 104 can determine which applications identified in display list 108 are system applications (e.g., system application 106) based on system application mapping 112. For example, system application 106 can be an application that is part of the operating system of client device 102. System application 106 can be an application that is pre-installed on client device 102 when client device 102 is purchased by a user, for example. Client device 102 identifies system applications based on a bundle identifier, as described above. Thus, client device 102 needs a way to convert the software application identifiers in display list 108 to the bundle identifiers used by client device 102 to identify the system applications. System application mapping 112 provides a way to convert application identifiers to bundle identifiers by mapping the system application identifiers generated by application store 160 to the bundle identifiers used by client device 102.

In some implementations, application manager 104 can compare the software application identifiers for system applications in system application mapping 112 to the software application identifiers in display list 108 to determine which software application identifiers in display list 108 correspond to system applications. Application manager 104 can determine that the software application identifiers that do not correspond to system applications correspond to software applications that should be automatically downloaded from application store 160.

In some implementations, application store 160 can provide an interface for authenticated user downloads (e.g., interface 162) and/or an interface for automatic device downloads (e.g., interface 164). For example, a user of client device 102 can request (e.g., purchase) software applications from application store 160 for installation on client device 102. These user initiated transactions can be performed using authentication interface 162. When a transaction is conducted using authentication interface 162, application store 160 can request user authentication information (e.g., account identifier, password, etc.) before allowing client device 102 to download the requested software application. Once the user is authenticated by the application store 160, application store 160 can allow client device 102 to download the requested software application.

In some implementations, when application manager 104 identifies software applications to automatically download based on the software application identifiers in display list 108, application manager 104 can request the identified software applications from application store 160 through automatic download interface 164. For example, automatic download interface 164 can allow client device 102 to automatically download software applications from application store 160 without user authentication. Application manager can send a download request including a software application identifier corresponding to a software application in display list 108 to application store 160 through automatic download interface 164. The download request can include a device identifier for client device 102, for example. In some implementations, the automatic downloading of software applications can be performed without providing any user information (e.g., user identifier, user account information, etc.) to application store 160. For example, in some implementations, the automatic download request does not include information identifying the user, an application store account associated with the user, a password for the user, or any other user-specific information.

In some implementations, when application store 160 receives an automatic download request from application manager 104 that identifies a software application, application manager can verify whether the identified application is available for automatic (e.g., user-less, user agnostic) download to client device 102. For example, the automatic download can be performed without user input and/or without user identification information (e.g., account identifier, user identifier, password, authentication information, etc.). For example, application store 160 can locate the requested software application (e.g., software application 168) in application database 166 based on the software application identifier received in the automatic download request. In some implementations, software application 168 can have corresponding metadata that includes the application identifier (e.g., generated by application store 160) and/or an automatic download data 172. For example, automatic download data 172 can be a Boolean value that indicates whether the corresponding application is available for automatic user-less downloads. If automatic download data 172 indicates that the requested software application can be automatically downloaded, application store 160 can allow application manager 104 to download the requested software application. Once application manager 104 downloads the requested software applications, application manager 104 can install the downloaded software application (e.g., installed software application 114) on client device 102.

In some implementations, application manager 104 can determine which applications on client device 102 should be presented on a user interface of client device 102. For example, client device 102 can be configured to generate a user interface (e.g., a home screen) that presents representations of applications installed on client device 102. A user can interact with the application representations (e.g., application icons, shortcuts, images, graphical objects, etc.) to invoke the corresponding application on client device 102.

### Determining which Applications to Present

In some implementations, application manager 104 on client device 102 can determine how to represent applications on a user interface of client device 102 based on display list 108, hide list 110, and/or system application mapping 112. For example, application manager 104 can determine which applications (e.g., installed applications, system applications, etc.) on client device 102 should be represented on a home screen of client device 102 based on display list 108, hide list 110, and/or system application mapping 112. In some implementations, applications displayed (e.g., represented by icons, images, graphical objects, etc.) on the user interface of client device 102 can be accessed or invoked by a user of client device 102. In some implementations, applications hidden from the user interface of client device 102 (e.g., not displayed or represented on the user interface) are not accessible by the user of client device 102.

In some implementations, application manager 104 can determine which applications to present on the user interface of client device 102 based on display list 108. For example, the applications presented on the graphical user interface can include automatically downloaded applications, user downloaded applications, and/or system applications. For example, after application manager 104 automatically downloads and installs the applications identified in display list 108, application manager 104 can present the applications (e.g., representations of the applications) identified in display list 108 on the user interface of client device 102.

In some implementations, applications manager 104 can identify system applications for presentation on the graphical user interface by comparing a software application identifier in display list 108 to system application mapping 112. If the software application identifier from display list 108 exists in system application mapping 112, application manager can use the corresponding bundle identifier in system application mapping 112 to identify the corresponding system application to display on the graphical user interface. In some implementations, system applications (e.g., system application 106) that are not identified in display list 108 will not be presented on the graphical user interface of client device 102. For example, system applications that are not identified in display list 108 will be hidden from view on the graphical user interface of client device 102.

In some implementations, application manager 104 can present previously downloaded and installed applications on the graphical user interface of client device 102. For example, applications purchased and installed by a user of client device 102 (e.g., not automatically installed) can be presented on the user interface regardless of whether the purchased applications are identified in display list 108.

In some implementations, application manager 104 can determine which installed applications to hide from view on the graphical user interface of client device 102 based on hide list 110. For example, applications (e.g., automatically installed applications, user installed applications, etc.) that are installed on client device 102 can be presented on the graphical user interface (e.g., home screen) of client device 102 by default. Hide list 110 provides a mechanism by which installed applications can be hidden from view on the graphical user interface of client device 102. For example, a software application installed on client device 102 may correspond to an annual media event. The media event application, for example, can be used to stream video from the event to client device 102 for presentation on a display device connected to client device 102. However, because the event only happens at a certain time of year, the media event application is not useful during times when the event is not occurring. Thus, even though the media event application is installed on client device 102, the media event application can be hidden during times of the year when the media event is not occurring. For example, during portions of the year when the media event is not occurring, client device 102 can receive hide list 110 including a software application identifier for the media event application. Application manager 104 can determine that the media event application identifier is in hide list 110 and hide the representation of the media event application from view on the graphical user interface of client device 102. During times of the year when the media event is occurring, client device 102 can receive hide list 110 that does not include the application identifier for the media event application. Because the media event application identifier is not included in hide list 110, application manager 104 can present a representation of the media event application on the graphical user interface of client device 102.

### Arranging Presentation of Applications

In some implementations, application manger 104 can determine how to arrange software application representations on the graphical user interface of client device 102 based on display list 108. For example, once application manager 104 determines which applications to present on the graphical user interface, application manager 104 can determine the order in which the corresponding application representations should be displayed on the graphical user interface based on the order in which the corresponding application identifiers are listed in display list 108.

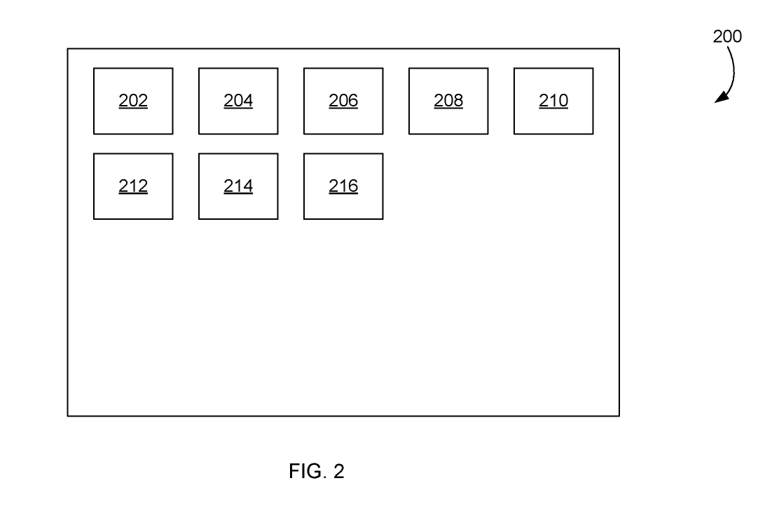

FIG. 2 illustrates an example graphical user interface 200 for presenting representations of applications installed on client device 102. For example, GUI 200 can be a home screen of client device 102 that presents graphical representations 202-216 of software applications available on client device 102. For example, graphical representation 202 (e.g., an image, icon, button, graphical object, etc.) can correspond to a system application of client device 102. Graphical representation 204 can correspond to an automatically downloaded application installed on client device 102. Graphical representation 214 can correspond to a user installed software application on client device 102.

In some implementations, applications (e.g., automatically installed applications, system applications, etc.) identified in display list 108 can be presented before other applications on client device 102. For example, the order for presenting applications (e.g., application representations) on GUI 200 can be from left to right and top to bottom. Thus, graphical representation 202 can occupy the first position on GUI 200. Graphical representation 204 can occupy the second position on GUI 200. Graphical representation 206 can occupy the third position on GUI 200, and so on from left to right in the top row of graphical representations. Once the top row is occupied, the next row down can be filled with graphical representations of applications from left to right, and so on. If six applications are identified in display list 108, the corresponding application representations can be displayed as graphical representations 202-212 in the order in which they appear in display list 108. For example, the first application identified in display list 108 can be represented by graphical representation 202. The second application identified in display list 108 can be represented by graphical representation 204. Other applications (e.g., not in display list 108) installed or available on client device 102 can occupy positions on GUI 200 after graphical representation 212 (e.g., graphical representations 214-216). Thus, the maker of client device 102 or the proprietor of application store 160 can use display list 108 to control how software applications are represented on a user interface of the computing device by populating display list 108 with application identifiers for software applications and system applications in a desired order.

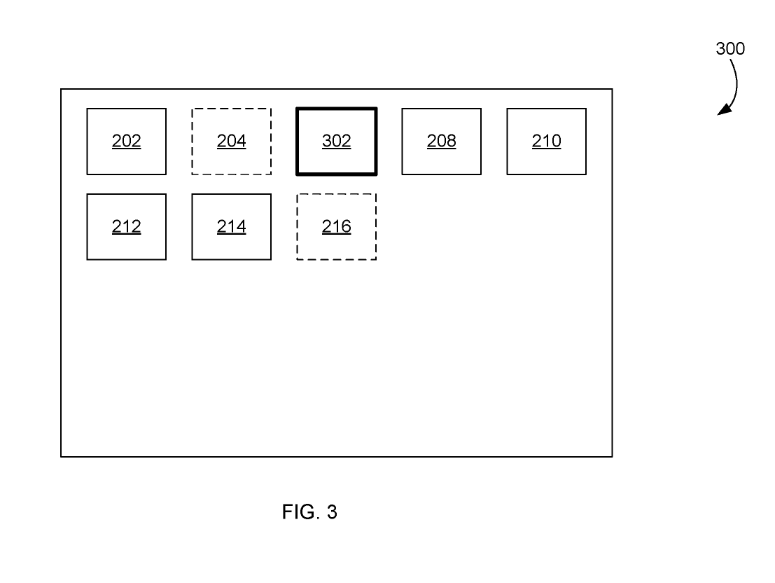

FIG. 3 illustrates an example graphical user interface 300 for presenting representations of applications installed on client device 102. For example, GUI 300 can correspond to GUI 200 of FIG. 2. In some implementations, after GUI 200 is presented by client device 102, client device 102 can receive a modified display list 108 and/or a modified hide list 110. For example, application manager 104 on client device 102 can periodically (e.g., each time client device 102 is powered on, every six hours, every 12 hours, etc.) request graphical user interface configuration information from user interface server 142 on server device 140. When application manager 104 receives display list 108 and/or hide list 110 that has been modified from the previous version of display list 108 and/or hide list 110, application manager can adjust the presentations of applications on GUI 200 to generate GUI 300.

For example, display list 108 may have previously included a system application corresponding to graphical representation 204. Application manager 104 would have determined that the system application was in the display list and presented graphical representation 204 on GUI 300. If a newly received version of display list 108 does not include the system application corresponding to graphical representation 204, graphical representation 204 can be removed from (e.g., hidden from view on) GUI 300.

In some implementations, if a newly received version of display list 108 includes a new application (e.g., application identifier) that was not included in the previous version of display list 108, application manager 104 can automatically install the new application and can add a representation (e.g., graphical representation 302) of the new application to GUI 300. The graphical representation of the new application can be positioned on GUI 300 according to the order in which the new application is identified in display list 108, as described above.

In some implementations, the order in which applications are displayed on GUI 300 can be adjusted based on a newly received display list 108. For example, display list 108 may specify a new order for presenting applications on GUI 300. A previous display list 108 may have specified that an application corresponding to graphical representation 208 should be displayed in the fourth position on GUI 300. However, a new display list 108 can specify that the application corresponding to graphical representation 208 should be displayed in the second position (e.g., corresponding to graphical representation 204. Accordingly, application manager 104 can move graphical representation 208 from the fourth position to the second position on GUI 300 when the updated display list 108 is received.

In some implementations, if a newly received version of hide list 110 includes an application identifier for an application that was not included in the previous version of hide list 110, the graphical representation of the application (e.g., graphical representation 216) previously displayed on GUI 300 can be removed from (e.g., hidden from view on) GUI 300. In some implementations, when a graphical representation of an application is hidden from view, the corresponding application can remain installed on client device 102. In some implementations, when a graphical representation of an application is hidden from view, the corresponding application can be deleted or removed from client device 102. Thus, application manager 204 can adjust the presentation of applications on GUI 300 based on updated display lists and/or hide lists received from user interface configuration server 142.

### Example Processes

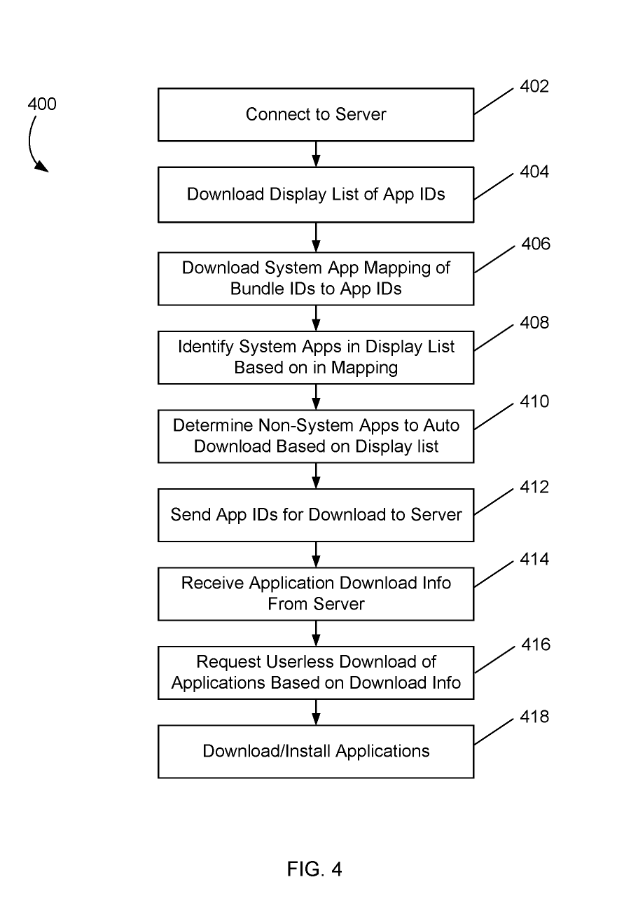

FIG. 4 is flow diagram of an example process 400 for automatically downloading applications from a server device. For example, process 400 allows for automatically downloading and installing applications to a client device without user input and without user authentication.

At step 402, client device 102 can connect to server device 140. For example, client device 102 can connect to server device 140 upon startup or powering on of client device 102. Client device 102 can connect to server device 140 periodically (e.g., every eight hours, every 24 hours, etc.) to request and obtain graphical user interface configuration data, as described above.

At step 404, client device 102 can download from server device 140 a list of applications to be displayed on a graphical user interface of client device 102. For example, client device 102 can request locale specific application configuration information from server device 140, as described above. Client device 102 can receive the locale specific application configuration information from server device 140, including the display list, as described above. The display list can include an ordered list of software application identifiers corresponding to applications to be presented on the graphical user interface (e.g., home screen) of client device 102. The display list can be used by client device 102 to determine which applications to download and install onto client device 102.

At step 406, client device 102 can download a system application mapping from server device 140. For example, the system application mapping can map application identifiers in the display list to bundle identifiers used by client device 102 to identify system applications configured on client device 102.

At step 408, client device 102 can identify system applications in the display list based on the system application mapping. For example, client device 102 can be preconfigured with system applications from the manufacturer or distributor of client device 102. The system applications can be built into the operating system of client device 102, for example. Client device 102 identifies system application using a bundle identifier, as described above. Client device 102 does not inherently use application identifiers (e.g., generated by application store 160) to identify system applications. However, the display list identifies both application store applications (e.g., applications downloadable from application store 160) and system applications using an application identifier. Thus, client device 102 can use the system application mapping to convert the application identifiers in the display list to corresponding bundle identifiers that client device 102 can use to identify system applications on client device 102 and/or in the display list.

At step 410, client device 102 can determine non-system applications to download based on the display list. For example, once the system applications are identified in the display list based on the system application mapping, client device 102 can determine that the non-system applications should be downloaded from application store 160 on server device 140.

At step 412, client device 102 can send the application identifiers from the display list to server device 140 to request a user-less (e.g., user agnostic) download of the corresponding applications from server device 140. For example, client device 102 can send the application identifiers for the non-system applications in the display list to application store 160.

Alternatively, client device 102 can send all of the application identifiers (e.g., system applications and non-system applications) in the display list to application store 160. Application store 160 can determine which application identifiers correspond to system applications and which application identifiers correspond to non-system applications. Thus, step 410 can be an optional step when application store 160 is configured to determine which application identifiers correspond to system applications and which application identifiers correspond to non-system applications.

In some implementations, application store 160 can confirm that a requested application is available for a user agnostic automatic download. For example, each application available through application store 160 can include metadata (e.g., a Boolean value) indicating whether the application can be downloaded automatically and without user authentication or identification. If the application metadata indicates that the application can be downloaded without user authentication or identification, then application store 160 can allow client device 102 to perform a user-less download of the application. If the application metadata indicates that the application cannot be downloaded without user authentication or identification (e.g., the user must purchase the application), then application store 160 will prevent client device 102 from downloading the corresponding application.

In some implementations, the user agnostic automatic download can be performed using an application update system of application store 160. For example, the application update system notifies client device 102 of version updates to applications installed on client device 102. To receive the notifications, client device 102 can send to application store 160 an application update request including a list of all applications installed on client device 102 and the corresponding application version numbers. Application store 160 can send an application update reply to client device 102 that identifies applications and corresponding latest version numbers of applications where the latest version number does not match the version number provided by client device 102. In some implementations, the application update reply from application store 160 to client device 102 can include links (e.g., URLs, addresses, etc.) that can be used by client device 102 to download the latest version of the applications identified in the update reply from application store 160. To initiate a user agnostic automatic download of applications, client device 102 can send the application identifiers in the display list to application store 160 in an application update request and specify version zero (e.g., version=0) as the version of the applications installed on client device 102. Application store 160 can send an application update response to client device 102 including links to the latest version of each of the applications, as described above. In some implementations, the application update response from application store 160 can exclude system applications.

At step 414, client device 102 can receive application download information from server device 140. For example, client device 102 can receive from application store 160 links to the latest version of each of the applications in the display list to be downloaded and installed on client device 102.

At step 416, client device 102 can request from server device 140 a user-less download of applications based on the application download information. For example, client device 102 can use the application links to request a download of the latest version of each of the applications identified in the application download information.

At step 416, client device 102 can download the requested applications from server device 140 and install the downloaded applications on client device 102. For example, application manager 104 on client device 102 can download the applications from application store 160 and install the applications on client device 102. Thus, client device 102 can be automatically configured with applications based on the display list received from server device 140 and without requiring any user information.

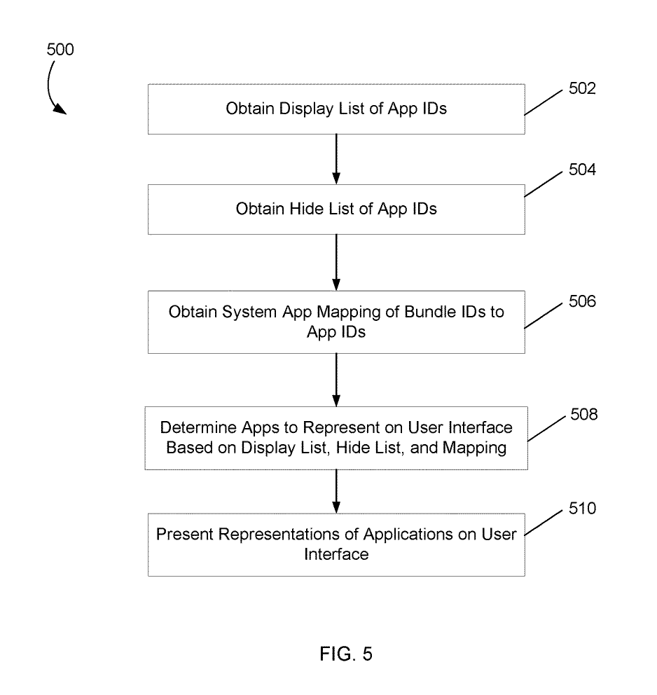

FIG. 5 is a flow diagram an example process 500 for displaying and hiding applications on a graphical user interface of client device 102. For example, process 500 allows a media vendor, device manufacturer, content provider, or some entity other than the user to control the look, feel, and organization of a graphical user interface of client device 102. In some implementations, process 500 can begin after process 400 is performed by client device 102.

At step 502, client device 102 can obtain a list of applications to be displayed on a graphical user interface of client device 102. For example, the display list can be obtained from server device 140, as described above. The display list can be obtained from local storage (e.g., hard drive, memory, etc.) on client device 102. The display list can be an ordered list of application identifiers. The application identifiers can correspond to application identifiers generated and used by application store 160 to identify applications available for purchase and/or download from application store 160. Client device 102 can determine which applications (e.g., automatically installed applications, user installed applications, system applications, etc.) installed on client device 102 should be displayed on the graphical user interface of client device 102.

At step 504, client device 102 can obtain a list of applications to be hidden from view on the graphical user interface of client device 102. For example, the hide list can be obtained from server device 140, as described above. The hide list can be obtained from local storage (e.g., hard drive, memory, etc.) on client device 102. The hide list can be a list of application identifiers. The application identifiers can correspond to application identifiers generated and used by application store 160 to identify applications available for purchase and/or download from application store 160. Client device 102 can determine which applications (e.g., automatically installed applications, user installed applications, system applications, etc.) installed on client device 102 should be hidden from view on the graphical user interface of client device 102.

At step 506, client device 102 can obtain a system application mapping. For example, the mapping can be obtained from server device 140, as described above. The mapping can be obtained from local storage (e.g., hard drive, memory, etc.) on client device 102. The mapping can include mappings of bundle identifiers for system applications to application identifiers generated by application store 160 for the system applications. Since client device 102 identifies system applications by bundle identifier, the mapping can be used by client device 102 to translate application identifiers in the display list to bundle identifiers used by client device 102 to identify system applications on client device 102. In some implementations, the application store generated identifier can be distinct from the bundle identifier. For example, the application store identifier can be an integer while the bundle identifier can be a character string. Thus, a system application can be associated with two different identifiers (e.g., a bundle identifier and an application identifier).

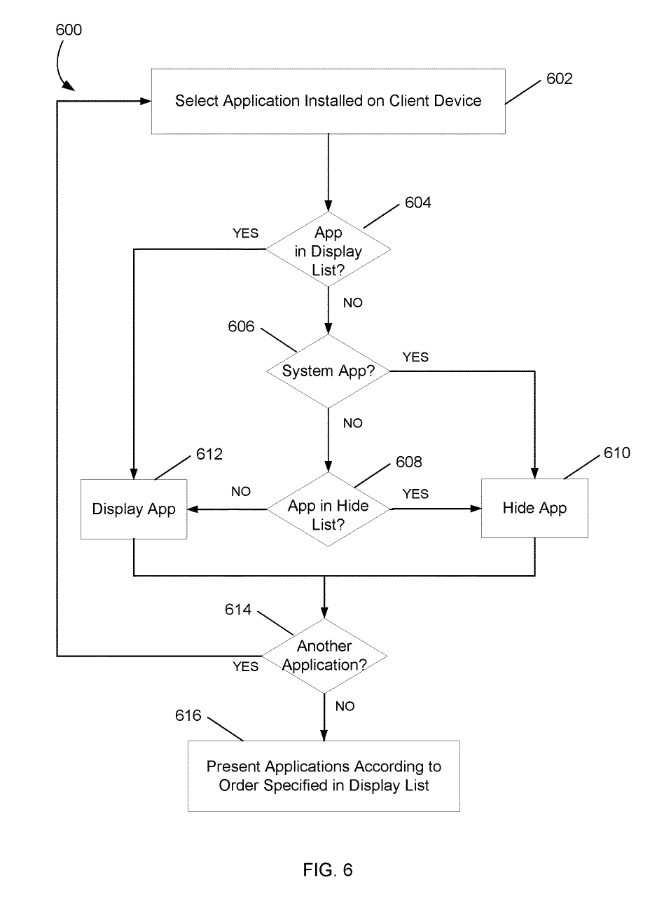

At step 508, client device 102 can determine which applications to represent on the graphical user interface of client device 102 based on the display list, the hide list, and the system application mapping. For example, process 600 of FIG. 6 below can be used by client device 102 to determine which applications to represent on the graphical user interface of client device 102.

At step 510, client device 102 can present representations of applications available on client device 102 on the graphical user interface of client device 102. For example, once client device 102 determines which applications are to be represented on the graphical user interface (e.g., home screen), client device 102 can present representations of the applications on the graphical user interface. In some implementations, the application representations (e.g., graphical objects, images, icons, etc.) can be arranged on the graphical user interface according to an order specified in the display list obtained at step 502.

FIG. 6 is a flow diagram of an example process 600 for determining which applications to present on a graphical user interface of client device 102. For example, process 600 can correspond to step 508 of FIG. 5.

At step 602, client device 102 can select an application installed on client device 102 to determine whether the application should be represented on the graphical user interface of client device 102. For example, client device 102 can select a system application, an automatically installed application, or a user installed application on client device 102.

At step 604, client device 102 can determine whether the application is in the display list stored on client device 102. For example, if the selected application is a system application, client device 102 can convert the bundle identifier of the system application into an application store generated application identifier using the system application mapping described above. If the selected application is an application downloaded from application store 160, the application will already be associated with an application store generated application identifier. Client device 102 can compare the application identifier for the selected application to the application identifiers in the display list to determine whether the application is identified in the display list. When the selected application is in the display list, client device 102 can determine that the application should be displayed on the graphical user interface of client device 102 at step 612.

At step 604, when the selected application is not included in the display list, client device 102 can determine whether the selected application is a system application. When the selected application is a system application that is not included in the display list, client device 102 can determine that the selected application should be hidden from view (e.g., not presented) on the graphical user interface of client device 102 at step 610.

At step 606, when the selected application is not included in the display list and is not a system application, client device 102 can determine whether the selected application is in the hide list. When the selected application is included in the hide list, client device 102 can determine that the selected application should be hidden from view (e.g., not presented) on the graphical user interface of client device 102 at step 610. When the selected application is not in the hide list, client device 102 can determine that the application should be displayed on the graphical user interface of client device 102 at step 612.

At step 614, once client device 102 has determined whether the selected application should be displayed or hidden on the graphical user interface of client device 102, client device 102 can determine whether there is another application installed on client device 102 that has not yet been analyzed using process 600. When there is another application installed on client device 102, client device 102 can select the next application at step 602. Client device 102 can determine whether the next application should be displayed or hidden according to the steps of process 600 described above.

At step 616, when there is not another application to analyze using process 600, client device 102 can present the applications to be displayed on the graphical user interface of client device 102 according to the order specified in the display list, as described above with reference to FIG. 2 and FIG. 3.

### Example System Architecture

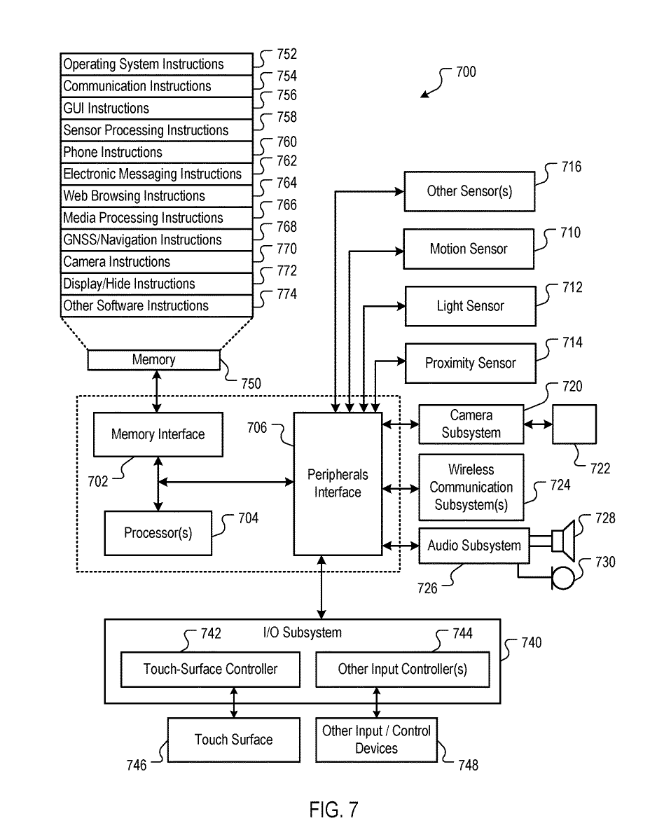

FIG. 7 is a block diagram of an example computing device 700 that can implement the features and processes of FIGS. 1-6. The computing device 700 can include a memory interface 702, one or more data processors, image processors and/or central processing units 704, and a peripherals interface 706. The memory interface 702, the one or more processors 704 and/or the peripherals interface 706 can be separate components or can be integrated in one or more integrated circuits. The various components in the computing device 700 can be coupled by one or more communication buses or signal lines.

Sensors, devices, and subsystems can be coupled to the peripherals interface 706 to facilitate multiple functionalities. For example, a motion sensor 710, a light sensor 712, and a proximity sensor 714 can be coupled to the peripherals interface 706 to facilitate orientation, lighting, and proximity functions. Other sensors 716 can also be connected to the peripherals interface 706, such as a global navigation satellite system (GNSS) (e.g., GPS receiver), a temperature sensor, a biometric sensor, magnetometer or other sensing device, to facilitate related functionalities.

A camera subsystem 720 and an optical sensor 722, e.g., a charged coupled device (CCD) or a complementary metal-oxide semiconductor (CMOS) optical sensor, can be utilized to facilitate camera functions, such as recording photographs and video clips. The camera subsystem 720 and the optical sensor 722 can be used to collect images of a user to be used during authentication of a user, e.g., by performing facial recognition analysis.

Communication functions can be facilitated through one or more wireless communication subsystems 724, which can include radio frequency receivers and transmitters and/or optical (e.g., infrared) receivers and transmitters. The specific design and implementation of the communication subsystem 724 can depend on the communication network(s) over which the computing device 700 is intended to operate. For example, the computing device 700 can include communication subsystems 724 designed to operate over a GSM network, a GPRS network, an EDGE network, a Wi-Fi or WiMax network, and a Bluetooth™ network. In particular, the wireless communication subsystems 724 can include hosting protocols such that the device 100 can be configured as a base station for other wireless devices.

An audio subsystem 726 can be coupled to a speaker 728 and a microphone 730 to facilitate voice-enabled functions, such as speaker recognition, voice replication, digital recording, and telephony functions. The audio subsystem 726 can be configured to facilitate processing voice commands, voice printing and voice authentication, for example.

The I/O subsystem 740 can include a touch-surface controller 742 and/or other input controller(s) 744. The touch-surface controller 742 can be coupled to a touch surface 746. The touch surface 746 and touch-surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 746.

The other input controller(s) 744 can be coupled to other input/control devices 748, such as one or more buttons, rocker switches, thumb-wheel, infrared port, USB port, and/or a pointer device such as a stylus. The one or more buttons (not displayed) can include an up/down button for volume control of the speaker 728 and/or the microphone 730.

In one implementation, a pressing of the button for a first duration can disengage a lock of the touch surface 746; and a pressing of the button for a second duration that is longer than the first duration can turn power to the computing device 700 on or off. Pressing the button for a third duration can activate a voice control, or voice command, module that enables the user to speak commands into the microphone 730 to cause the device to execute the spoken command. The user can customize a functionality of one or more of the buttons. The touch surface 746 can, for example, also be used to implement virtual or soft buttons and/or a keyboard.

In some implementations, the computing device 700 can present recorded audio and/or video files, such as MP3, AAC, and MPEG files. In some implementations, the computing device 700 can include the functionality of an MP3 player, such as an iPod™. The computing device 700 can, therefore, include a 36-pin connector that is compatible with the iPod. Other input/output and control devices can also be used.

The memory interface 702 can be coupled to memory 750. The memory 750 can include high-speed random access memory and/or non-volatile memory, such as one or more magnetic disk storage devices, one or more optical storage devices, and/or flash memory (e.g., NAND, NOR). The memory 750 can store instructions for execution by the processors described above. The memory 750 can store an operating system 752, such as Darwin, RTXC, LINUX, UNIX, OS X, WINDOWS, or an embedded operating system such as VxWorks.

The operating system 752 can include instructions for handling basic system services and for performing hardware dependent tasks. In some implementations, the operating system 752 can be a kernel (e.g., UNIX kernel). For example, operating system 752 can implement the automatic application downloading and presentation features as described with reference to FIGS. 1-6.

The memory 750 can also store communication instructions 754 to facilitate communicating with one or more additional devices, one or more computers and/or one or more servers. The memory 750 can include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GNSS/Navigation instructions 768 to facilitate GNSS and navigation-related processes and instructions; and/or camera instructions 770 to facilitate camera-related processes and functions.

The memory 750 can store other software instructions 772 to facilitate other processes and functions, such as the automatic application downloading and presentation processes and functions as described with reference to FIGS. 1-6.

The memory 750 can also store other software instructions 774, such as web video instructions to facilitate web video-related processes and functions; and/or web shopping instructions to facilitate web shopping-related processes and functions. In some implementations, the media processing instructions 766 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 750 can include additional instructions or fewer instructions. Furthermore, various functions of the computing device 700 can be implemented in hardware and/or in software, including in one or more signal processing and/or application specific integrated circuits.

What is claimed is:

1. A method comprising:
receiving, by a computing device, a first listing of applications to be presented on a display of the computing device;
automatically communicating, by the computing device to a server device through a network interface device of the computing device, a request to download applications identified in the first listing of applications;
automatically downloading, by the computing device from the server device, the applications; and
causing, by the computing device, representations of the downloaded applications to be presented on a user interface of the computing device based on the first listing of applications.

2. The method of claim 1, wherein downloading the applications is performed without providing user-specific information to the server device.

3. The method of claim 1, further comprising:
determining, by the computing device, that a built-in system application of the computing device is not included in the first listing of applications; and
preventing the system application from being presented on the user interface of the computing device.

4. The method of claim 1, further comprising:
determining, by the computing device, that a user-installed application is not included in the first listing of applications; and
causing the user-installed application to be presented on the user interface of the computing device.

5. The method of claim 1, further comprising:
receiving, by the computing device, a second listing of applications to be hidden from view on the display of the computing device;
determining, by the computing device, that an installed application on the computing device is in the second listing of applications; and
preventing the installed application from being presented on the user interface of the computing device.

6. The method of claim 1, wherein the first listing of applications identifies an order for presenting the applications in the first listing, and further comprising:
causing, by the computing device, representations of the downloaded applications to be presented on the user interface of the computing device according to the order identified by the first listing.

7. The method of claim 6, wherein the applications identified in the first listing are presented on the user interface of the computing device in order before other applications installed on the computing device.

8. A non-transitory computer-readable medium including one or more sequences of instructions that, when executed by one or more processors, cause:
receiving, by a computing device, a first listing of applications to be presented on a display of the computing device;
automatically communicating, by the computing device to a server device through a network interface device of the computing device, a request to download applications identified in the first listing of applications;
automatically downloading, by the computing device from the server device, the applications; and
causing, by the computing device, representations of the downloaded applications to be presented on a user interface of the computing device based on the first listing of applications.

9. A system comprising:
one or more processors; and
a non-transitory computer-readable medium including one or more sequences of instructions that, when executed by the one or more processors, cause:
receiving, by the system, a first listing of applications to be presented on a display of the computing device;
automatically communicating, by the system to a server device through a network interface device of the system, a request to download applications identified in the first listing of applications;
automatically downloading, by the system from the server device, the applications; and
causing, by the system, representations of the downloaded applications to be presented on a user interface of the system based on the first listing of applications.
